(19) United States
(12) Patent Application Publication
(10) Pub. No.: US 2026/0124827 A1
(43) Pub. Date: May 7, 2026

(54) SHAPED PART FOR MANUFACTURING PIECES OF FURNITURE, HAVING INCREASED STABILITY DUE TO ALUMINUM PARTICLES HAVING A LIMITED WEIGHT, PROCESS FOR MANUFACTURING SAID SHAPED PART, AND USE

(71) Applicant: puren GmbH, Überlingen (DE)

(72) Inventors: Maximilian KARA, Aschaffenburg (DE); Martin KRAUSS, Lützelbach (DE); Andreas SCHÖHL, Elsenfeld (DE)

(21) Appl. No.: 19/130,044

(22) PCT Filed: Nov. 14, 2023
(86) PCT No.: PCT/EP2023/081753

§ 371 Date: Jun. 6, 2025

(30) Foreign Application Priority Data
Nov. 15, 2022 (EP) 22207508.7

(51) Int. Cl. B32B 27/20; B32B 5/18; B32B 7/12; B32B 9/00; B32B 9/04; B32B 15/095; B32B 15/20; B32B 27/40

(52) U.S. Cl. CPC B32B 27/20; B32B 5/18; B32B 7/12; B32B 9/002; B32B 9/045; B32B 15/095; B32B 15/20; B32B 27/40; B32B 2255/26; B32B 2264/1052; B32B 2266/0278; B32B 2307/718; B32B 2307/72; B32B 2307/7376; B32B 2311/24; B32B 2479/00

(57) ABSTRACT

A shaped part is disclosed that includes a polyurethane piece and two outer layers. The shaped part is by its structure suitable for the production of pieces of furniture and, because of the composition of the polyurethane piece using aluminum particles having a limited weight, has increased stability with respect to the customary prior art shaped parts used in the production of pieces of furniture. Also disclosed is a method for the production of the shaped part, the use of the shaped part for the production of pieces of furniture, and the pieces of furniture produced from the shaped part.

### CROSS-REFERENCE TO RELATED APPLICATIONS

This patent application is a U.S. national stage application of international patent application PCT/EP 2023/081753, filed on Nov. 14, 2023, which is based on and claims priority to European patent application EP 22207508.7, filed on Nov. 15, 2022, the contents of which are incorporated herein by reference.

### FIELD

The invention concerns a shaped part which is composed of a polyurethane piece and two outer layers and which, due to its structure, is suitable for the manufacturing of pieces of furniture and, due to the composition of the polyurethane piece and its production by aluminum particles of a limited weight, has an increased stability compared to conventional shaped parts from the prior art which are used in the production of pieces of furniture. The invention also concerns a method for the production of the shaped part and the use of the shaped part for the production of pieces of furniture and the pieces of furniture produced therefrom.

### BACKGROUND

Pieces of furniture have long been known in human history and can be produced from a variety of materials. Aluminum has proven to be very suitable for pieces of furniture because it has a low specific weight and a good mechanical stability. It is therefore possible to produce pieces of furniture which are easily portable and are also durable and have some load capacity. Moreover, aluminum is resistant in air and can be treated in such a way that it has a glossy and visually attractive surface. Herein the aluminum is usually provided as pipes or tubes, from which in turn the load-bearing frames of the pieces of furniture are produced. Depending on the desired construction of the respective piece of furniture, walls or wall pieces may also be produced from aluminum, for example in the form of panels. In principle, however, all materials are suitable for the production of pieces of furniture, wherein those materials which have a low specific weight and a good mechanical stability are preferred.

In the production of the pieces of furniture, the problem comes up that the parts intended for the production of the piece of furniture must be fastened with respect to one another. In the mutual fastening of the parts, screw connections are very often used. These have the advantage of being releasable and may moreover be provided for the desired purpose, for example such that they have a certain screw depth depending on the desired fastening strength. However, the aluminum structure is often less suitable for screw threads because it does not have a sufficient thickness and many material parts intended for the production of pieces of furniture are hollow. For this reason, solutions have been proposed in the prior art which provide the inner hollow space of the material parts intended for the production of pieces of furniture with fillers, said fillers making the weight of pieces of furniture increase only insignificantly, but filling the hollow spaces with solid material for improved mechanical strength.

Document CN102242560A describes a matted composite material, made of an aluminum-plastic composite material which consists in succession of a matted aluminum plate, a first polymer binder film, an inner polyurethane layer, a polymer adhesive film and a further aluminum plate with a total of five layers. This composite material matted on one side is in particular used for the production of high-end quality pieces of furniture, for example in indoor spaces and in automobiles. The document does not give any indications regarding the construction of the pieces of furniture themselves and also not regarding the mechanical strength of the described composite material.

Document EP2796258A2 describes a two-dimensional electrical surface conductor with an insulating layer, comprising a 5 mm thickness layer of polyurethane foam, two electrically conductive aluminum foils, two layers of a 5 mm thickness natural cork agglomerate, furthermore LED light-emitting diodes with electrodes of different lengths which have at their ends an epoxy varnish layer for insulation, and an electric power source. By the cork layer, the surface conductor offers an insulating and at the same time mechanically flexible inner layer for the installation of electrical components for the production of an electrical component having an electrically conductive surface. The document also mentions the possible production of pieces of furniture from the two-dimensional electrical surface conductor. The document likewise does not give any indications regarding the construction of the pieces of furniture themselves and also not regarding the mechanical strength of the described two-dimensional electrical surface conductor.

Document DE202016106033U1 describes a panel with a core made of an extruded rigid-foam material, which is on at least one surface side provided with a cover layer made of a high-pressure laminated material (HPL), wherein the panel has on its end faces a layer of a weathering-resistant plastic for edge covering. In an embodiment of the described invention, the core of the panel consists of a closed-cell extruded polystyrene (XPS)1 and the end-face layer for the edge covering consists of a thermoplastic synthetic material. The described panel is suitable, for example, for tabletops of garden furniture or tables for outdoor gastronomy or other furniture standing permanently outdoors, such as for example furniture in public spaces.

There is therefore a quest for materials for the production of pieces of furniture which are constructed from two outer layers as the structuring component and have in their interior a filler of sufficient mechanical strength and depth for the fastening of connecting fastening means. These connecting fastening means are typically screws. It is further desirable that the material does not involve any restrictions with regard to the optical appearance of the surface compared with an aluminum surface from the prior art, and that it has a low specific weight such that the pieces of furniture are easily portable. The material should be present as a shaped part and ideally in the form of panels, which may then be assembled to form the desired pieces of furniture.

As a result of this, there is the task of providing shaped parts which have two outer layers as the structuring component and which are suitable for the production of pieces of furniture and which have an increased mechanical stability compared with the shaped parts from the prior art. There is also the task of providing a method for the production of these shaped parts.

### SUMMARY

The present invention solves this task by means of a shaped part which is suitable for the production of pieces of furniture and which, in a rectilinear see-through, comprises an inner layer that consists of a polyurethane piece having a density of 400-700 kg/m 3 and composed of chopped and compressed shreds of polyurethane material mixed with aluminum particles, and which comprises two outer layers, the outer layers having a thickness of 0.10 mm to 4.00 mm, the aluminum particles having a weight of 0.0005 to 2.00 g, and the adhesive layer having an application quantity of 40 to 600 g/m2 .

What is claimed is a shaped part for the production of furniture, comprising an inner layer that consists of a polyurethane piece, and
two outer layers, and
between the outer layers and the inner layer respectively one adhesive layer, with a further adhesive layer on the other side of the polyurethane piece, and which is characterized in that
the polyurethane piece of the inner layer consists of chopped and compressed shreds of polyurethane material mixed with aluminum particles and a binder and has a density of 400-700 kg/m3, and
the outer layers have a layer thickness of 0.10-4.00 mm, and
the aluminum particles have a weight of 0.0005 to 2.00 g, and
the adhesive layers have an application quantity of 40 to 600 g/m2 .

The denominations of the individual layers refer to a rectilinear view through the shaped part. If the shaped part has a panel shape, two outer layers are applied onto the inner layer. If the shaped part is a pipe or a tube, the number of the two outer layers is given in a rectilinear view through the pipe or tube. For a pipe or a tube, the two outer layers then form a radial outer layer.

According to the invention, the aluminum particles have a limited weight of 0.0005 to 2.00 g. An optimum mechanical strength of the polyurethane piece is achieved by said weight of the aluminum particles. In an embodiment, the aluminum particles may have a weight of 0.001 to 0.5 g. The aluminum particles may, for example, be aluminum shreds. In an exemplary embodiment, the aluminum particles are aluminum shreds having a weight of 0.001 to 0.5 g. In a further embodiment, the aluminum particles are aluminum shreds having a weight of 0.01 to 0.2 g.

For the purpose of realizing the invention, the outer layer should have a layer thickness of 0.10 mm to 4.00 mm. In an embodiment of the invention, the outer layer has a layer thickness of 0.80 mm to 2.00 mm. These layer thicknesses have been found to be optimal both for the production of the furniture pieces and for the resulting stability of the furniture pieces and their specific weight.

According to the invention, an application quantity of 40 to 600 g/m2 has been found to be especially advantageous for the adhesive layer. As a result, an optimal ratio of adhesive strength and weight is achieved. This enables further optimization of the ratio of adhesive strength and weight. It is also possible to use a narrower range of, for example, 80 to 160 g/m2 . This narrower range is very material-friendly for the materials used. As a result of the defined application quantity, the adhesive layer no longer has to be provided with an epoxy primer. An epoxy primer is recommended only if an aluminum plate is selected as the outer layer and an IK-PUR prepolymer is selected as the adhesive layer.

The chopping and compressing of shreds of polyurethane material is known in the prior art and is described, for example, in document DE10228473A1. Binders, such as are described, for example, in document U.S. Pat. No. 3,717,597A, are suitable as binders for the chopped and compressed shreds of polyurethane material and for the aluminum particles. An epoxy primer is described, for example, in document DE3042788A1.

In a preferred and practicable embodiment of the shaped part, the outer layer of the shaped part is made of aluminum. This material has a low specific weight and is resistant and durable. Aluminum is also insensitive to weathering effects. Moreover, it can be provided in an optically attractive outer shape. The outer layer has the same shaping as the shaped part and, in a conventional embodiment, is made of aluminum. If the shaping of the outer layer is a panel and if said panel is made of aluminum, the outer layer made of aluminum forms an aluminum panel.

In a further embodiment of the shaped part, the outer layer is made of a stone veneer. Like aluminum, said stone veneer has a low specific weight and an externally aesthetic effect. The stone veneer is inexpensive to produce.

In a further embodiment of the shaped part, the material of which the outer layer is made is selected from high-pressure pressed laminate, continuous-pressed laminate, carbon fiber, resin-bound textiles, concrete, mineral-bound materials, ceramic materials, glasses, metals, weathering-resistant synthetic materials or precious woods. These materials constitute further embodiments of the outer layer, which differ in the outer appearance of the outer layer depending on the use and the wishes of the end product user. These materials also have a relatively low specific weight and a good durability.

The metals from which the outer layer may likewise be formed are, for example, brass, zinc or copper. Compared to aluminum, these metals have a somewhat higher specific weight, but are also resistant and durable. These metals moreover have a different outer appearance than aluminum, so that, depending on the use of the end product, it is also possible to accommodate further wishes of the end product user with regard to the outer appearance of the end product.

The weathering-resistant synthetic materials are, for example, polymethylene methacrylate (PMMA), polyvinyl chloride (PVC), polyethylene (PE) or polyurethane (PU). These synthetic materials are inexpensive and easy to handle. The precious woods are, for example, teak or mahogany. These precious woods have an externally aesthetic effect and are also comparably weathering-resistant as compared to other woods.

All the materials mentioned for the outer layer may be combined with one another, depending on the wishes of the end product user and depending on the desired appearance.

In an exemplary embodiment, the adhesive layer is realized as a 1K-PUR prepolymer. This adhesive hardens quickly and connects the parts that are to be glued with one another reliably and permanently. An adhesive layer made of a 1K-PUR prepolymer is described, for example, in document WO2017121540A1.

In a further embodiment of the shaped part, the adhesive layer is realized as an acrylate adhesive, of an in its initial state solvent-containing adhesive, a dispersion adhesive, or a two-component adhesive. These adhesives are somewhat less expensive than the 1K-PUR prepolymer and are favorably usable for connecting the parts that are to be glued.

In the most popular embodiment of the invention, the shaped part is planar and has a panel shape. A panel may well be used for building pieces of furniture. In a simple embodiment, the panel is screwed with a further panel at a right angle in order to build a deposition surface. However, it is also possible within the scope of the invention to produce a shaped part that is not realized as a panel. In an exemplary embodiment, pipes or tubes may also be produced as a shaped part according the present invention. In principle, any geometrically possible shape may be selected for the shaped part according the present invention.

In a further advantageous embodiment of the present invention, the polyurethane piece of the inner layer has a density of 550-660 kg/m3. This density has been found to be optimal, on the one hand, in order to further have the furniture pieces constructed therewith present a low weight and, on the other hand, in order to achieve sufficient mechanical stability for the screw connection.

In a further embodiment of the invention, the outer layer is varnished with a polyester varnishing having a layer thickness of 10-25 μm as the outermost layer, which forms the outermost layer of the shaped part and covers the outer layer. This layer thickness has been found to be optimal for a protection of the surface of the outer layer and for creating a surface which has a pleasant grip feeling and is optically attractive. This polyester layer is usually applied onto all aluminum panels of the shaped part as the outermost layer. However, it is also possible within the scope of the invention to apply the polyester layer onto only one aluminum panel, preferably in that case onto the aluminum panel which will later form the outer side of a piece of furniture. The application of a polyester layer onto the outer layer is particularly preferred if the outer layer is made of aluminum.

What is also claimed is a method for the production of the shaped part or parts described above. What is claimed is a method comprising the method steps of chopping a polyurethane foam in a chopper to produce polyurethane shreds, and adding a binder to the polyurethane shreds and mixing, such that a mixture is created, and compressing the resulting mixture to form a polyurethane piece, and applying an adhesive layer to at least one side of the polyurethane piece, with a further adhesive layer on the other side of the polyurethane piece, and pressing outer layers onto the side of the polyurethane piece on which the adhesive layers are applied,
and which is characterized in that
aluminum particles having a weight of 0.0005 to 2.00 g are added to the polyurethane shreds before the compression, and
that the compression for forming a polyurethane piece is carried out with such a pressure and for such a duration that the polyurethane piece has a density of 400-700 kg/m3 after the compression, and
that when the adhesive layers are applied, an application quantity of 40 to 600 g/m2 is selected.

In the most popular embodiment, the method is used to produce several shaped parts, which are then assembled to form a piece of furniture. However, in principle it is possible within the scope of the invention to produce any number of shaped parts according to the invention or also only one shaped part according to the invention. Within the scope of the invention, it is also possible that a further polyester layer having a thickness of 10-25 μm is applied onto the outer side of the outer layer, which does not come into contact with the adhesive layer. The application of a polyester layer onto the outer layer is particularly preferred if the outer layer is made of aluminum.

In an embodiment of the invention, the compression for forming a polyurethane piece is carried out with such a pressure and for such a duration that after the compression the polyurethane piece has a density of 550-660 kg/m3. The density of the polyurethane piece may well be controlled via the pressure and the duration of the compression.

In a further embodiment of the method for the production of the shaped part or parts described above, an aluminum layer is pressed on as the outer layer. This material has a low specific weight and is resistant and durable. Aluminum is also insensitive to weathering effects. Moreover, it may be pressed on in such a way that it has an optically attractive outer shape. The aluminum layer as the outer layer may then form an aluminum panel.

In a further embodiment of the method, a stone veneer is pressed on as an outer layer. The stone veneer is preferably produced before it is pressed on. The stone veneer may be produced by applying a resin onto stone material, applying glass fibers onto the applied resin and removing the glass fibers by hand. The removed glass fibers with the stone material are then pressed on as a stone veneer onto the side of the polyurethane piece on which the adhesive layer is applied. The production of the stone veneer is simple and inexpensive.

For pressing on as an outer layer, the material of which the outer layer is made may be selected from high-pressure pressed laminate, continuous-pressed laminate, carbon fiber, resin-bound textiles, concrete, mineral-bound materials, ceramic materials, glasses, metals, weathering-resistant synthetic materials or precious woods. The processing of such materials for pressing on as an outer layer is known in the prior art.

If high-pressure pressed laminate or continuous-pressed laminate is used for the production of a shaped part, this is firstly produced in a separate method step. For this purpose, at least two paper layers are impregnated with melamine resin or phenolic resin, as a result of which a thermosetting synthetic material is created from the melamine resin or phenolic resin after hardening. This thermosetting synthetic material is then pressed on as an outer layer onto the side of the polyurethane piece on which the adhesive layer has been applied.

In a further embodiment of the method, the metals which are pressed on as an outer layer are brass, zinc or copper. In a further embodiment of the method, the weathering-resistant synthetic materials which are pressed on as an outer layer are polymethylene methacrylate, polyvinyl chloride, polyethylene or polyurethane. In a further embodiment of the method, the precious woods which are pressed on as an outer layer are teak or mahogany.

An adhesive layer realized of a 1 K-PUR prepolymer can be applied as an adhesive layer onto at least one side of the polyurethane piece. This adhesive hardens quickly and connects the parts that are to be glued with one another permanently. It is also possible that an acrylate adhesive, an in its initial state solvent-containing adhesive, which is allowed to dry to obtain the adhesive effect, a dispersion adhesive or a two-component adhesive is applied as an adhesive layer onto the at least one side of the polyurethane piece. In the case of an in its initial state solvent-containing adhesive, the solvent must first be allowed to evaporate in order to obtain the desired gluing effect. For this, solvent-containing adhesives are somewhat cheaper to purchase and easier to handle.

The adhesives mentioned may also be used in combination.

In an embodiment of the production of the above-described shaped part for the production of pieces of furniture, the production of the piece of furniture is carried out by milling a hollow space into the shaped part and screwing at least two shaped parts with each other to form a piece of furniture. The shaped parts described above are ideally suitable for this purpose. The milled-in hollow space may comprise a fastening pattern. For this purpose, the fastening pattern can be milled into the milled-in hollow space. In a simple embodiment, the milled-in hollow space is a milled-in cylinder and the fastening pattern is a screw thread. The fastening is then carried out by means of a fastening element. In a simple embodiment, the fastening element is a screw. The milled-in hollow space and the fastening pattern have an increased stability and provide the fastening pattern with an increased stability when loaded by fastening elements, as these do not tear out and enable a stable connection of the shaped parts to form a piece of furniture.

What is also claimed is the use of a shaped part as described above for the production of pieces of furniture. Although the production of pieces of furniture constitutes a preferred use of the shaped parts described above, it is in principle possible to use the shaped parts for any purpose for which they are suitable.

In the production of pieces of furniture, it is also possible to use shaped parts that are realized as panels and are planar. Herein there may be open side surfaces, which are not covered by the outer layer. These open side surfaces may subsequently be provided with a cover panel made of the desired material. The desired material may, for example, be aluminum. For cover, the open side surfaces may also be provided with a cover panel made of a suitable commercially available plastic. For this purpose, for example, UV-stabilized polypropene (PP), UV-stabilized polyethylene (PE), polyvinyl chloride (PVC) or acrylonitrile-butadiene-styrene copolymer (ABS) are suitable as synthetic materials. In an exemplary embodiment, the cover panel made of the desired material has a thickness of 0.40 mm to 2.00 mm. In an exemplary embodiment, the cover panel made of plastic has a thickness of 1.0 mm to 2.0 mm. Like the cover panel made of the desired material, the cover panel made of a synthetic material may be glued onto the polyurethane piece by means of an adhesive layer made of one of the adhesives mentioned. For this purpose, preferentially a 1K-PUR prepolymer is used with an epoxy primer. As a result of the cover, an abutment edge is realized on the open side surface by the cover panel.

Finally, what is also claimed is a piece of furniture produced from one or several of the shaped parts described above.

The invention has the advantage of providing mechanically stable shaped parts for the construction of pieces of furniture. Due to said shaped parts, these pieces of furniture are further characterized by a low specific weight, and thus favorable portability, and by a good surface resistance and an optically attractive appearance. The shaped parts have an increased stability compared with the shaped parts from the prior art, such that they allow the secure drilling-in of screw threads.

In the following, the invention is described in greater detail using twenty-one drawings, wherein said drawings merely constitute embodiments of the invention and the invention is not limited to these embodiments.

### BRIEF DESCRIPTION OF THE DRAWINGS

FIG. 1 shows the shaped part with the individual layers in a non-assembled state in an oblique front view.

FIG. 2 shows the shaped part with the individual layers in a side view.

FIG. 3 shows a shaped part with a screw in a milled-in hollow space in a side view.

FIG. 4 shows a shaped part with a fastening nut above the milled-in hollow space in a front view.

FIG. 5 shows a loosely assembled shaped part with milled-in hollow spaces in an oblique side view.

FIG. 6 shows a screw for insertion into a milled-in hollow space.

FIG. 7 shows a fixedly assembled shaped part with the screw in the milled-in hollow spaces in an oblique side view.

FIG. 8 shows two shaped parts assembled with screws in a side view.

FIG. 9 shows a shaped part an object that has been put on and fastened, in a side view.

FIG. 10 shows a shaped part onto which an object has been screwed with a special screw in a side view.

FIG. 11 shows a shaped part onto which an object has been screwed with a special screw having a special rotary head in a side view.

FIG. 12 shows a shaped part with milled-in hollow spaces and with a dowel-expansion connection in a side view.

FIG. 13 shows two shaped parts which are assembled with a dowel in a side view.

FIG. 14 shows two shaped parts which are assembled with a double turn-in dowel in a side view.

FIG. 15 shows two shaped parts which are assembled with an expansion screw in a side view.

FIG. 16 shows two shaped parts which are assembled with an invisible plug connection on the narrow sides in a side view.

FIG. 17 shows two shaped parts which are assembled with an invisible plug connection on the wide sides in a side view.

FIG. 18 shows two shaped parts which are assembled with a biscuit joint in a side view.

FIG. 19 shows two shaped parts which are assembled with an angled spline in a side view.

FIG. 20 shows the use of the shaped part for the production of a piece of furniture from above.

FIG. 21 shows the use of the shaped part for the production of a piece of furniture in an oblique front view.

### DETAILED DESCRIPTION

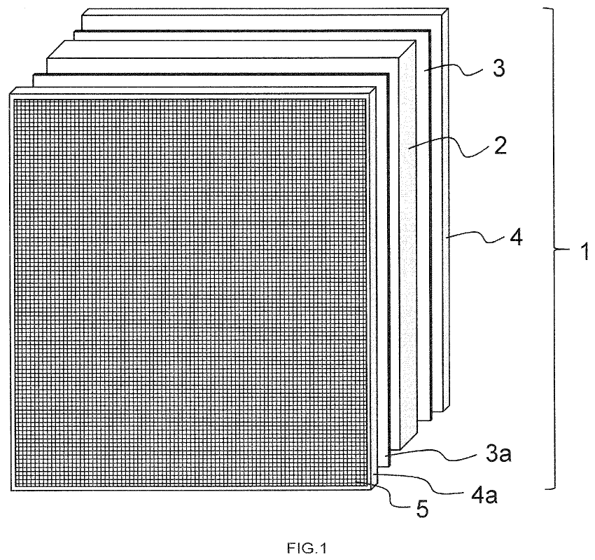

The drawing FIG. 1 shows the shaped part (1) with the individual layers in a non-assembled state in an oblique front view. The individual layers can be seen, which are assembled and thereby form the shaped part (1). The innermost layer is the inner layer, which is implemented by the polyurethane piece (2). The polyurethane piece (2) is obtained by chopping a polyurethane foam in a chopper to produce polyurethane shreds, adding a binder to the polyurethane shreds, adding aluminum particles having a weight of 0.0005 to 2.00 g, mixing to create a mixture, and compressing the resulting mixture to form a polyurethane piece (2). The next layer starting from the polyurethane piece (2) in a rectilinear see-through view is the adhesive layer (3). The adhesive layer (3) is applied onto the polyurethane piece (2) with an application quantity of 40 to 600 g/m2 . The next layer is the outer layer (4), which is realized as an aluminum panel. Here the second adhesive layer (3a) and the second outer layer (4a) as a further outer layer (4), which are applied onto the other side of the inner layer in a rectilinear see-through view, are also visible. The last layer in this embodiment is then the outermost layer, which is realized as a polyester varnishing (5) on the second outer layer (4a). The first outer layer (4) may also have a polyester varnishing (5) on the surface that is not visible here. As a result, the surfaces of the outer layers (4, 4a) are protected and a pleasant-feeling grip is created.

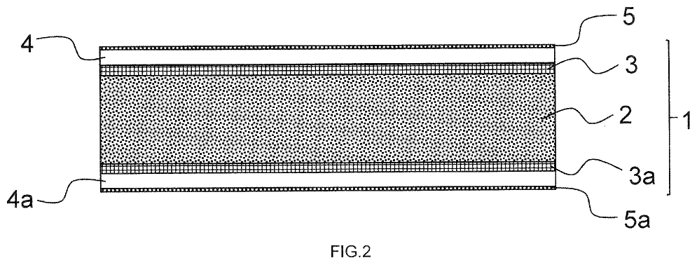

The drawing FIG. 2 shows the shaped part (1) with the individual layers in a side view. The individual layers are here assembled to form the finished shaped part (1). The inner layer, which is realized as the polyurethane piece (2), the adhesive layer (3), the outer layer (4), which is realized as the aluminum panel, and the polyester coating (5), which forms the outermost layer, can be seen. Here the adhesive layer (3a) on the other side of the polyurethane piece (2) and the polyester varnishing (5a), in a rectilinear see-through view on the other side of the polyurethane piece (2), can also be seen.

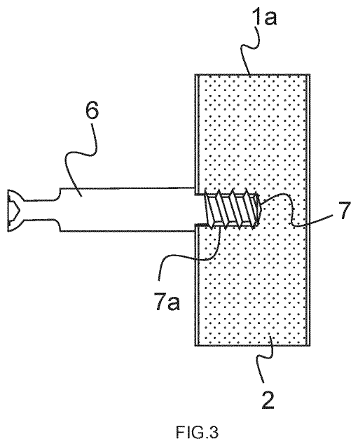

The drawing FIG. 3 shows a first shaped part (1a) with a screw (6) in a milled-in hollow space (7) in a side view. A hollow space (7) is milled into the shaped part (1), which is composed of the described layers. A screw (6) is screwed into the hollow space (7). As a result, the milled-in hollow space (7) has a fastening pattern (7a) that is realized as a screw thread. The polyurethane piece (2) has sufficient strength to enable a screw (6) to be screwed in and a fastening pattern (7a) to be screwed in by means of the screw (6). The screw thread in the first shaped part (1a) may also be turned in by means of a drill. The polyurethane piece (2) according to the invention enables sufficient stability for this type of fastening.

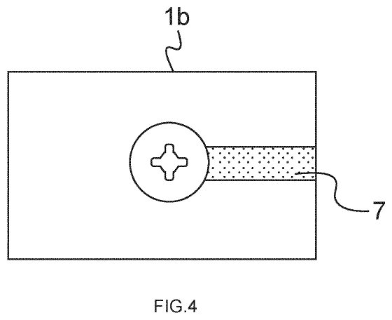

The drawing FIG. 4 shows a second shaped part (1b) with a fastening nut (8) above the milled-in hollow space (7) in a front view. A hollow space (7) has been milled into the shaped part (1). A fastening nut (8) has been introduced into this hollow space (7), as the milled-in hollow space (7) also opens towards the fastening nut (8). This second shaped part (1b) constitutes the counterpart for fastening the shaped part (1) of the drawing FIG. 3. The screw (6) of the shaped part (1) of the counterpart is inserted into the milled-in hollow space (7). The fastening nut (8) is then rotated, so that the screw (6) is fastened in the milled-in hollow space (7). As a result, the two shaped parts (1a, 1b) can be fastened against one another. The polyurethane piece (2) according to the invention, which cannot be seen in this figure, enables sufficient stability for this type of fastening.

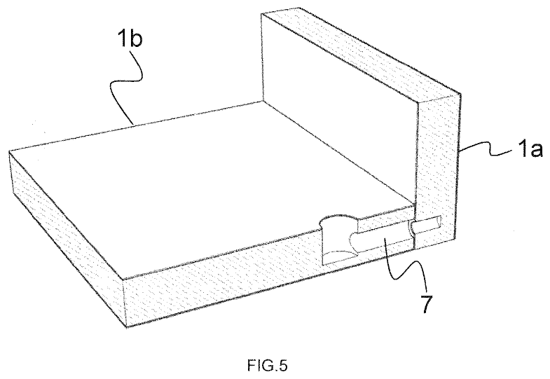

The drawing FIG. 5 shows two loosely assembled shaped parts (1a, 1b) with milled-in hollow spaces (7) in an oblique side view. The hollow spaces (7) have been worked in for an intended screw (6) and an intended fastening nut (8). It can clearly be seen in this drawing that the milled-in hollow space (7) opens towards the intended fastening nut (8).

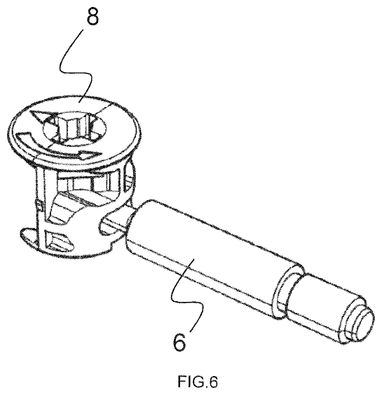

The drawing FIG. 6 shows a screw (6) from the prior art for insertion into a milled-in hollow space (7). In this embodiment, the screw (6) has no thread, but is fastened by means of the fastening nut (8).

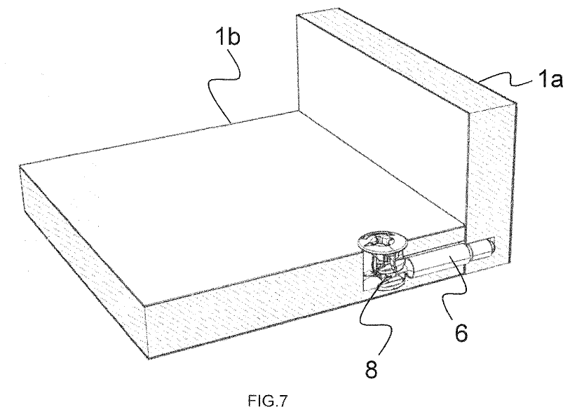

The drawing FIG. 7 shows two fixedly assembled shaped parts (1a, 1b) with the screw (6) in the milled-in hollow spaces (7) in an oblique side view. The stability of the polyurethane piece (2) enables stable screwing-in of the screw (6) and the fastening nut (8).

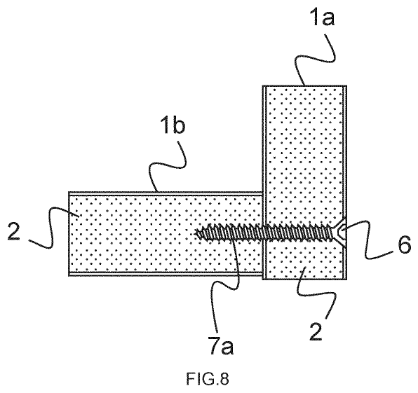

The drawing FIG. 8 shows two shaped parts (1) assembled with screws (6) in a side view. Two shaped parts (1a, 1b) can be seen, which are fitted together via a screw (6). In this embodiment, the screws (6) have a thread. The shaped parts (1a, 1b) with the polyurethane piece (2) provide sufficient stability and strength to fasten the first shaped part (1a) and the second shaped part (1b) against one another by means of the screw (6). It is possible to screw, without further pretreatment, the screw (6) into the shaped parts (1a, 1b) for fastening. As a result, with the screwing-in a screw thread is created as a fastening pattern (7a). Preferably, however, the hollow space (7) is milled in and, with the milling-in, a fastening pattern (7a) is milled in.

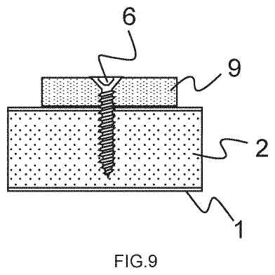

The drawing FIG. 9 shows a shaped part (1) with an object that has been put on and fastened, in a side view. A shaped part (1) with a screwed-on object (9) can be seen. The polyurethane piece (2) provides the shaped part (1) with sufficient stability for screwing a screw (6) in and for fastening the object (9) on the shaped part (1) by means of the screw (6).

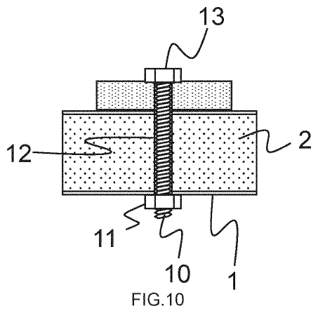

The drawing FIG. 10 shows a shaped part (1) onto which an object (9) has been screwed using a special screw (10) from the prior art, in a side view. A shaped part (1) can be seen, onto which an object (9) has been screwed with a special screw (10) with a screw nut (11). The special screw (10) has a rotary head (13) and a screw thread (12), which is fastened in the milled-in hollow space (7) by means of a screw nut (11). The stability of the polyurethane piece (2) enables stable screwing-in of the special screw (10).

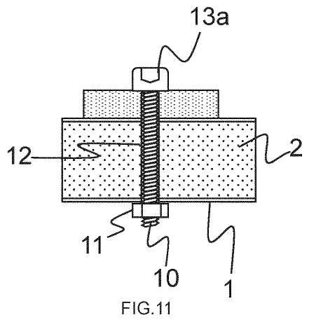

The drawing FIG. 11 shows a shaped part (1) onto which an object (9) has been screwed using a special screw (10) with a special rotary head, in a side view. A shaped part (1) can be seen, onto which an object (9) has been screwed using a special screw (10) with a special rotary head (13a), in a side view. The special screw (10) has a special rotary head (13a), which can be rotated using a hex wrench. This special screw (10) with its special rotary head (13a) also has a screw thread (12) fastened in the milled-in hollow space (7) by means of a screw nut (11). The stability of the polyurethane piece (2) enables stable screwing-in of the special screw (10).

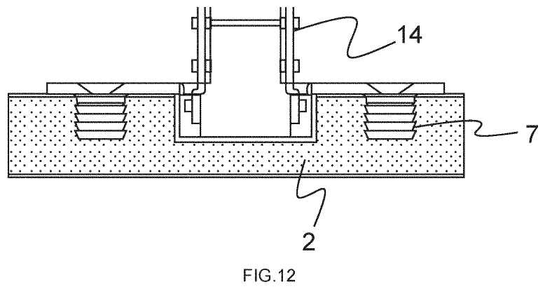

The drawing FIG. 12 shows a shaped part (1) with milled-in hollow spaces (7) and with a dowel-expansion connection (14) in a side view. The dowel-expansion connection (14) is embedded in the milled-in hollow spaces (7) and is expanded for fastening. This type of fastening is possible because the polyurethane piece (2) has increased stability.

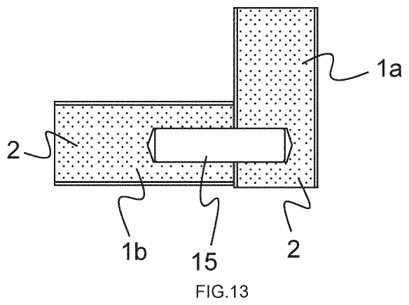

The drawing FIG. 13 shows two shaped parts (1a, 1b) which are assembled using a dowel (15), in a side view. The dowel (15) is driven into a shaped part (1a, 1b) and the shaped parts (1a, 1b) are fastened against one another by means of pressing power. This type of fastening is also only possible because the polyurethane pieces (2) have increased stability.

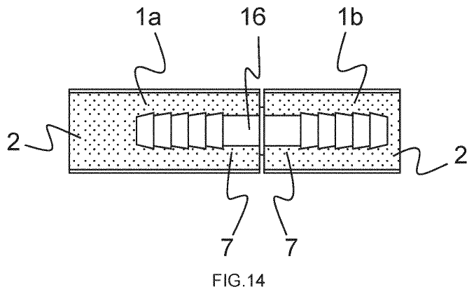

The drawing FIG. 14 shows two shaped parts (1a, 1b) which are assembled using a double turn-in dowel (16), in a side view. Here, two shaped parts (1a, 1b) are fastened against one another using a so-called double turn-in dowel (16). Said double turn-in dowel (16) is first fastened in one shaped part (1a) by being driven into the milled-in hollow space (7) and is then pressed with the shaped part (1a) into the milled-in hollow space (7) of the other shaped part (1b). In this way, the two shaped parts (1a, 1b) are fastened against one another. This type of fastening is only possible because the polyurethane piece (2) has increased stability.

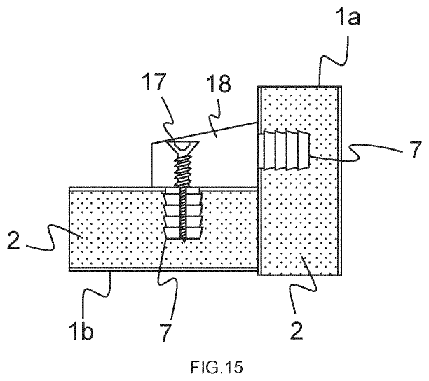

The drawing FIG. 15 shows two shaped parts (1a, 1b) which have been assembled using an expansion screw (17), in a side view. An expansion screw (17) presses a corner fitting (18) against the milled-in hollow spaces of two shaped parts (1a, 1b). As a result, the shaped parts (1a, 1b) are firmly pressed together.

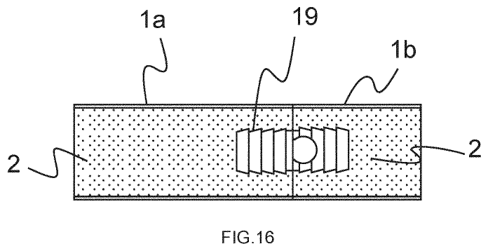

The drawing FIG. 16 shows two shaped parts (1a, 1b) which have been assembled using an invisible plug connection (19) on the narrow sides, in a side view. The invisible plug connection (19) is pressed into the milled-in hollow spaces (7) of one shaped part (1a) and is then pressed into the milled-in hollow space (7) of the other shaped part (1b). This connection is somewhat less stable than a connection with a double turn-in dowel (16), but is suitable for a loose fastening.

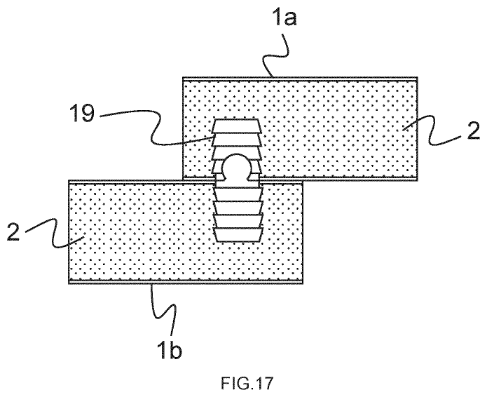

The drawing FIG. 17 shows two shaped parts (1a, 1b) which have been assembled using an invisible plug connection (19) on the wide sides, in a side view. This fastening is carried out in the same way as in the fastening in the drawing FIG. 16, wherein here the shaped parts (1a, 1b) are fastened against one another sideways.

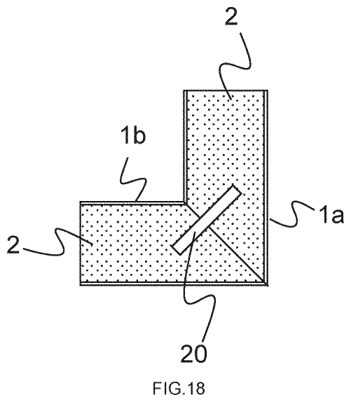

The drawing FIG. 18 shows two shaped parts (1a, 1b) which have been assembled using a biscuit joint (20), in a side view. Two angled shaped parts (1a, 1b) can be seen, which are fastened against one another by means of a biscuit joint (20). Biscuit joints (20) are suitable for assembling angled shaped parts (1a, 1b). The biscuit joint (20) is placed into a milled-in hollow space (7) of the first shaped part (1a) and is then pressed with the first shaped part (1a) into the milled-in hollow space (7) of the other shaped part (1b). This type of fastening is possible due to the increased stability of the polyurethane pieces (2) of the two shaped parts (1a, 1b).

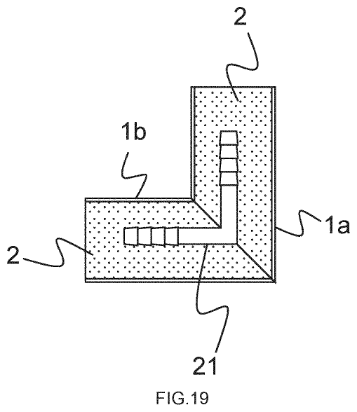

The drawing FIG. 19 shows two shaped parts (1a, 1b) which are assembled using an angled spline (21), in a side view. The two shaped parts (1a, 1b) are fastened against one another in the same way as with a biscuit joint (20), wherein the biscuit joint (20) is replaced by an angled spline (21).

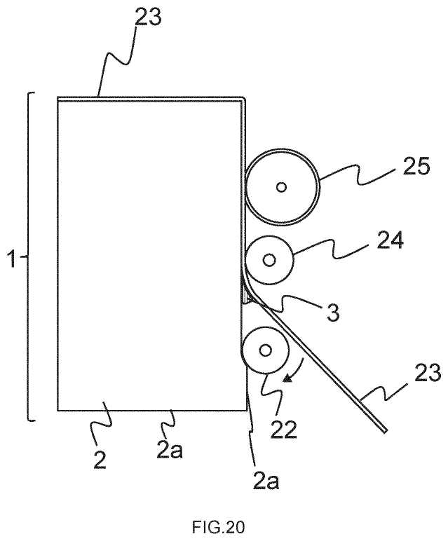

The drawing FIG. 20 shows the use of the shaped part (1) for the production of a piece of furniture from above. The outer layer (4) of the shaped part (1) can be seen from above. The polyurethane piece (which cannot be seen here) is firstly given a smooth grounding on the open side surfaces (2a) of the polyurethane piece (2) using a rough-milling cutter (22). The rough-milling cutter (22) is equipped with a grinding surface and rotates in the direction of the arrow. Herein it comes into contact with the open side surface (2a) of the polyurethane piece (2) at the grinding surface, wherein the open side surface (2a) is given a smooth grounding. When the rough-milling cutter (22) has been passed through, an adhesive layer (3) is applied onto the open side surface (2a) of the polyurethane piece (2), for example by a calender. Before the gluing, the adhesive layer (3) is heated to the temperature required for gluing by heating, for example by means of a laser, by hot air or by near-infrared radiation (NIR). Then a cover panel (23) made of aluminum or of plastic plastic implemented of UV-stabilized polypropene (PP), UV-stabilized polyethylene (PE), polyvinyl chloride (PVC) or acrylonitrile-butadiene-styrene copolymer (ABS)-is then applied onto the adhesive layer (3) for covering. In an exemplary embodiment, the cover panel (23) made of plastic has a thickness of 1.0 mm to 2.0 mm.

The application of the cover panel (23) is carried out using a roller (24). After the application of the cover panel (23), the resulting abutment edge of the cover panel (23) is smooth-polished using a form-milling cutter (25).

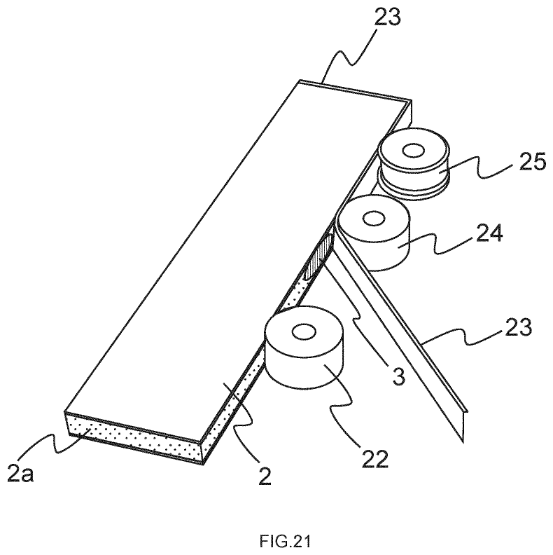

The drawing FIG. 21 shows the use of the shaped part (1) for the production of a piece of furniture in an oblique front view. The polyurethane piece (2) and the outer layer (4) can be seen. When a rough-milling cutter (22) has passed over the open side surface (2a) of the polyurethane piece (2), an adhesive layer (3) is applied. Then a cover panel (23) is applied. The cover panel (23) is applied onto the adhesive layer (3) using a roller (24). As a result, an abutment edge is created. After the roller (24), a form-milling cutter (25) is also run over the cover panel (23), thus giving a smooth surface to the cover panel (23). After this procedure, the shaped part (1) can be used for the further production of a piece of furniture.

1. A shaped part for the production of furniture, comprising an inner layer that consists of a polyurethane piece, and
two outer layers, and
between the outer layers and the inner layer respectively one adhesive layer, with a further adhesive layer on the other side of the polyurethane piece,
wherein
the polyurethane piece of the inner layer consists of chopped and compressed shreds of polyurethane material, mixed with aluminum particles and a binder, and has a density of 400-700 kg/m³, and
the outer layers have a layer thickness of 0.10-4.00 mm, and
the aluminum particles have a weight of 0.0005 to 2.00 g, and
the adhesive layers have an application quantity of 40 to 600 g/m².

2. The shaped part according to claim 1, wherein the outer layer is made of aluminum or of stone veneer.

3. The shaped part according to claim 1, wherein the material which the outer layer consists of is selected from high-pressure pressed laminate, continuous-pressed laminate, carbon fiber, resin-bound textiles, concrete, mineral-bound materials, ceramic materials, glasses, metals, weathering-resistant synthetic materials or precious woods.

4. The shaped part according to claim 1, wherein the aluminum particles are aluminum shreds having a weight of 0.001 to 0.5 g.

5. The shaped part according to claim 1, wherein the adhesive layer is made of a 1 K-PUR prepolymer.

6. The shaped part according to claim 1, wherein the adhesive layer is constructed of an acrylate adhesive, of an in its initial state solvent-containing adhesive, of a dispersion adhesive or of a two-component adhesive.

7. The shaped part according to claim 1, wherein the shaped part is planar and has a panel shape.

8. The shaped part according to claim 1, wherein the polyurethane piece of the inner layer has a density of 550-660 kg/m³.

9. The shaped part according to claim 1, wherein the outer layer is varnished with a polyester varnishing, having a layer thickness of 10-25 μm, as the outermost layer.

10. A method for the production of a shaped part according to claim 1, comprising the method steps of
chopping a polyurethane foam in a chopper to produce polyurethane shreds, and
adding a binder to the polyurethane shreds and mixing, such that a mixture is created, and
compressing the resulting mixture to form a polyurethane piece and
applying an adhesive layer onto at least one side of the polyurethane piece and a further adhesive layer onto the other side of the polyurethane piece and
pressing outer layers having a layer thickness of 0.10-4.00 mm, onto the side of the polyurethane piece on which the adhesive layers have been applied,
wherein
aluminum particles, having a weight of 0.0005 to 2.00 g, are added to the polyurethane shreds before the compression, and
the adhesive layers are applied with an application quantity of 40 g/m² to 600 g/m² onto the at least one side of the polyurethane piece and
the compression for forming a polyurethane piece is carried out with such a pressure and for such a duration that after the compression the polyurethane piece has a density of 400-700 kg/m³.

11. The method for the production of a shaped part according to claim 10, wherein stone veneer is pressed on as an outer layer, wherein the stone veneer is obtained by applying a resin onto stone material, applying glass fibers onto the applied resin and removing the glass fibers by hand, and the removed glass fibers with the stone material are pressed on as a stone veneer onto the side of the polyurethane piece which the adhesive layer has been applied onto.

12. The method for the production of a shaped part according to claim 10, wherein the material which the outer layer consists of is selected from high-pressure pressed laminate, continuous-pressed laminate, carbon fiber, resin-bound textiles, concrete, mineral-bound materials, ceramic materials, glasses, metals, weathering-resistant synthetic materials or precious woods.

13. The method for the production of a shaped part according to claim 12, wherein the high-pressure pressed laminate or the continuous-pressed laminate is produced before it is pressed onto the outer layer by impregnating at least two paper layers with melamine resin or phenolic resin, as a result of which a thermosetting synthetic material is created from the melamine resin or phenolic resin after hardening, and this thermosetting synthetic material is pressed as an outer layer onto the side of the polyurethane piece which the adhesive layer has been applied onto.

14. The method for the production of a shaped part according to claim 10, wherein in order to produce the adhesive layer, an acrylate adhesive, an in its initial state solvent-containing adhesive, which is allowed to dry in order to obtain the adhesive effect, a dispersion adhesive or a two-component adhesive is applied onto the at least one side of the polyurethane piece or the adhesive layer is made of a 1 K-PUR prepolymer.

15. A use of a shaped part according to claim 1 for the production of pieces of furniture.

16. The use of a shaped part according to claim 15, wherein the production of the piece of furniture is carried out by drilling a screw thread into the shaped part and screwing at least two shaped parts with each other to form a piece of furniture.

17. A piece of furniture, produced from a shaped part according to claim 1.
